(19) United States
(12) Patent Application Publication
(10) Pub. No.: US 2024/0391155 A1
(43) Pub. Date: Nov. 28, 2024

(54) FIBER COMPOSITE STRUCTURE

(71) Applicant: Tesla, Inc., Austin, TX (US)

(72) Inventors: Kevin Shenk, South Lake Tahoe, CA (US); Shakeel Theodore, Fremont, CA (US); Bharath Swaminathan, Livermore, CA (US); Alessandro Bernardis, Fremont, CA (US); Shuzhen Wei, Fremont, CA (US); Harsh Modi, Pleasanton, CA (US); Connor Bergin, Oakland, CA (US); Rahul Thakkar, Livermore, CA (US)

(21) Appl. No.: 18/671,112

(22) Filed: May 22, 2024

Related U.S. Application Data
(60) Provisional application No. 63/550,340, filed on Feb. 6, 2024.
(60) Provisional application No. 63/468,233, filed on May 22, 2023.

(51) Int. Cl. B29C 51/02; B29C 45/14; B29C 51/00; B29C 51/26; B29C 51/42; B29D 99/00; B29K 23/00; B29K 77/00; B29K 105/08; B29K 277/00; B29K 307/04; B29K 311/10

(52) U.S. Cl. CPC B29C 51/02; B29C 45/14; B29C 51/004; B29C 51/264; B29D 99/0003; B29C 51/421; B29C 2793/0018; B29C 2793/0027; B29C 2793/0081; B29K 2023/12; B29K 2023/14; B29K 2077/00; B29K 2105/08; B29K 2277/10; B29K 2307/04; B29K 2311/10

(57) ABSTRACT

A beam including a formed member comprising a blank shape of a fiber material infused with a thermoplastic that is formed into a first shape and an over molded member comprising an injected molded material that is bonded to the formed member. A method of forming a beam, the method may include cutting a first material into a blank shape, heating the blank shape, thermoforming the blank shape into a formed member with a first tool, and injecting the injection molded tool with a second material.

### CLAIM OF PRIORITY

This patent application claims the benefit of priority, under 35 U.S.C. Section 119(e), to Shenk et al, U.S. Provisional Patent Application Ser. No. 63/468,233, entitled “FIBER COMPOSITE STRUCTURE,” filed on May 22, 2023 (Attorney Docket No. 6474.080PRV), to Shenk et al, U.S. Provisional Patent Application Ser. No. 63/550,340, entitled “FIBER COMPOSITE STRUCTURE,” filed on Feb. 6, 2024 (Attorney Docket No. 6474.080PV2), both of which provisional applications are hereby incorporated by reference herein in their entirety.

### TECHNICAL FIELD

This application relates to a fiber composite structure used to form a beam. Specifically this application relates to a formed fiber and thermoplastic composite in combination with an injection molding that is used to form a car beam.

### BACKGROUND

In the context of beams there is a need for lightweight strong beams that are easily manufacturable. Traditional beams rely on steel structures that can be heavy and require additional secondary operations to form geometries. There exist some solutions but they fail to produce a manufacturable, light weight structure, with all the additional features required.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of one or more embodiments of the system and methods provide several advantages over traditional systems and methods.

In some aspects, the techniques described herein relate to a process of manufacturing a beam, the process including: heating a blank shape, the blank shape including a composite material that includes a fiber and a first thermoplastic; thermoforming, using a tool, the blank shape to form a thermoformed member; and overmolding, using the tool, the thermoformed member with a molding material that includes a second thermoplastic to form the beam, wherein overmolding the thermoformed member causes the first thermoplastic and the second thermoplastic to bond to each other.

In some aspects, the techniques described herein relate to a process, further including cutting a composite material sheet to form the blank shape.

In some aspects, the techniques described herein relate to a process, wherein thermoforming the blank shape includes: placing the blank shape into the tool; and compressing the blank shape into the thermoformed member.

In some aspects, the techniques described herein relate to a process, wherein overmolding the thermoformed member includes injecting the molding material into the tool.

In some aspects, the techniques described herein relate to a process, wherein the thermoformed member has a first shape, and wherein overmolding causes the molding material to have a second shape that is different from the first shape.

In some aspects, the techniques described herein relate to a process, wherein the molding material is selected from a group consisting of polypropylene homopolymers, polypropylene copolymers, nylon homopolymers, nylon copolymers, and combinations thereof.

In some aspects, the techniques described herein relate to a process of manufacturing a beam, the process including: heating a blank shape, the blank shape including a composite material that includes a fiber and a first thermoplastic; thermoforming, using a first tool, the blank shape to form a thermoformed member; and overmolding, using a second tool different from the first tool, the thermoformed member with a molding material that includes a second thermoplastic to form the beam, wherein overmolding the thermoformed member causes the first thermoplastic and the second thermoplastic to bond to each other.

In some aspects, the techniques described herein relate to a process, wherein the first tool is a compression forming tool, a thermoforming tool, or an injection molding tool.

In some aspects, the techniques described herein relate to a process, wherein the beam is a cross vehicle beam.

In some aspects, the techniques described herein relate to a process, further including cutting a composite material sheet to form the blank shape.

In some aspects, the techniques described herein relate to a process, further including: processing the thermoformed member; and inserting the thermoformed member into the second tool.

In some aspects, the techniques described herein relate to a process, wherein processing the thermoformed member includes removing excess material from the thermoformed member, or adding mounting holes or slots to the thermoformed member.

In some aspects, the techniques described herein relate to a process, wherein processing the thermoformed member includes heating the thermoformed member.

In some aspects, the techniques described herein relate to a beam including: a thermoformed member including a fiber material and a first thermoplastic material; and an overmolded member including a second thermoplastic material, wherein the first thermoplastic material and the second thermoplastic material are bonded to each other to connect the thermoformed member and the overmolded member.

In some aspects, the techniques described herein relate to a beam, wherein the thermoformed member is devoid of steel, aluminum, or a metallic material.

In some aspects, the techniques described herein relate to a beam, wherein the overmolded member includes one or more mounting holes, or one or more mounting slots.

In some aspects, the techniques described herein relate to a beam, wherein the overmolded member includes one or more overmolding straps to at least partially wrap the thermoformed member.

In some aspects, the techniques described herein relate to a beam, wherein the beam is a cross vehicle beam.

In some aspects, the techniques described herein relate to a beam, wherein the fiber material is a carbon fiber, and wherein the first thermoplastic material and the second thermoplastic material are nylon.

In some aspects, the techniques described herein relate to a beam, wherein the thermoformed member has a U cross sectional shape.

In some aspects, a process of manufacturing a structural element comprises controlling the temperature during thermoforming and overmolding to a specific range that optimizes the bonding between a first thermoplastic and a second thermoplastic, wherein the specific temperature range is between 200° C. and 250° C.

In some aspects, a process of manufacturing a structural element comprises applying a post-processing treatment selected from the group consisting of heat treatment, ultraviolet (UV) radiation, and chemical treatment, to enhance at least one of durability, environmental resistance, and mechanical strength of the structural element.

In some aspects, a method for recycling or reusing materials from a structural element comprises disassembling the structural element at the end of its lifecycle and separating the fiber material and thermoplastic material for reuse or recycling.

In some aspects, a structural element comprises integrated sensors or electronic components configured to monitor at least one of structural integrity, stress levels, and environmental conditions, wherein the sensors or electronic components are embedded during the overmolding process.

In some aspects, a process of manufacturing a structural element comprises customizing the properties of the structural element to be specifically suited for applications in environments selected from the group consisting of electric vehicles, hybrid vehicles, aerospace, and marine environments.

### BRIEF DESCRIPTION OF THE DRAWINGS

These and other features, aspects and advantages of the present invention are described herein with reference to drawings of preferred embodiments, which are intended to illustrate, and not to limit, the present invention.

FIG. 1 is a perspective view of an embodiment of a beam, according to some examples.

FIG. 2 is a view of the blank used to form the beam, according to some examples.

FIG. 3 is a perspective view of a thermoformed member, according to some examples.

FIG. 4 is a perspective view of an embodiment of a beam, according to some examples.

FIG. 5 is an illustration of the method of forming the beam, according to some examples.

FIG. 6 is an alternative illustration of the method shown in FIG. 5, according to some examples.

FIG. 7 is an illustration of the method of forming the beam, according to some examples.

FIG. 8 is an alternative illustration of the method shown in FIG. 7, according to some examples.

FIG. 9 is an illustration of a method of forming a beam, such as the beam of FIG. 1, according to some examples.

### DETAILED DESCRIPTION

Generally described, one or more aspects of the present disclosure relate to a beam for a vehicle and a method of forming the beam. The beam structure and method disclosed herein have general applicability in many products and industries including automotive, recreational, shipping, boating aerospace, and robotics. For ease of description the beam and method will be discussed in the context of vehicles, specifically vehicle cross beams. However, the application of the beam and method of forming said beam disclosed herein are not limited to vehicles and have applicability in many industries. Further this method may be used outside of beams to form other structural shapes. This manufacturing method may create shapes other than a beam, such as complex 3D surface geometries, with applications including but not limited to console structures, steering column support brackets, trim support brackets, or local reinforcement to trim components.

Traditional approaches to vehicle cross beams have relied on steel or other metals, resulting in heavy beams. Further bonding or mounting components to the steel or other metals requires additional operations or components. These shortcomings have resulted in increased costs, manufacturing time, and inefficiencies in vehicles, especially in electric vehicle where weight is important.

To address some of the deficiencies associated with a traditional system, certain embodiments described herein provide a beam for a vehicle comprising a thermoformed portion and an injection molded portion. The resulting beam and method of creating said beam provide a low weight beam with sufficient structural integrity.

The beam includes a thermoformed member, which may also be referred to as a formed member, and an over molded portion. In certain embodiments, the thermoformed member begins the process as a blank shape. In certain embodiments, the blank shape is cut from a material sheet. The material used for the thermoformed member may be a first material. The first material may be a combination material including a fiber material and a thermoplastic. For example, the first material may be a fiber material infused, impregnated, or injected with a thermoplastic.

In certain embodiments, the blank shape may then be heated. In certain embodiments, the blank shape may be heated via a double sided heating apparatus such that the material is evenly heated on both sides. The blank shape is then inserted into a first tool. The first tool may be a compression forming tool, a thermoforming tool, an injection molding tool, or any combination thereof. The blank shape may then be formed into a formed member. The formed member in the present embodiment has a U shape cross section but may be another shape. In some embodiments, the formed member remains in the first tool and in other embodiments of the process the formed member is removed from the first tool.

When the formed member is removed from the first tool the overmolding may occur in a second tool, or the formed member may be reinserted into the first tool. The formed member may undergo secondary operations prior to being inserted into the second tool and/or reinserted into the first tool used for overmolding. The secondary operations may include, for example, removing excess material with a computer numerical control (CNC) machine, adding mounting holes or slots, or any other similar operation.

When the formed member remains in the first tool, overmolding occurs in the same tool (e.g., the first tool) in which thermoforming occurred. Overmolding is the process of forming one material over the top of another or after another has been formed. Overmolding may include injecting an injection moldable material, a second material, into the first tool. The second material used for injection molding is selected so as to directly bond with the formed member. The material used for injection molding may be the same material as the thermoplastic.

Once the formed member is overmolded with an injection molded material it is removed from the first tool or the second tool. In certain embodiments, the overmolded formed member may undergo additional secondary operations at this time.

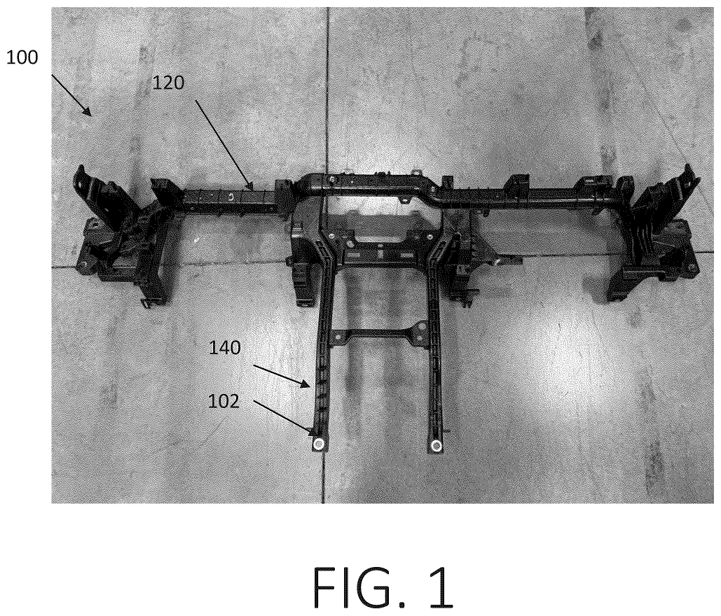

FIG. 1 is view of an embodiment of the beam 100 in accordance with this application. The beam 100 comprises a thermoformed member 120 (herein also referred to as a formed member 120) and an overmolded portion 140. The thermoformed member 120 is bonded to the overmolded portion 140. The formed member 120 may be made of a fiber material and a thermoplastic. The fiber material may be carbon fiber, glass fiber, flax, aramid, Kevlar, any variety of other fiber materials, or any combination thereof. The thermoplastic may be polypropylene homopolymers, polypropylene copolymers, nylon homopolymers, nylon copolymers, or a variety of other thermoplastics. The overmolded portion 140 may reinforce, support, or structurally assist the formed member 120 to create a stronger beam 100. The overmolded portion 140 may be made of any of the thermoplastic materials used in the formed member 120 such as, polypropylene homopolymers, polypropylene copolymers, nylon homopolymers, or nylon copolymers.

The beam 100 may include a plurality of mounting features 102. The mounting features 102 may be formed directly in the thermoformed member 120 or the overmolded portion 140. The mounting features 102 may be mounting holes, mounting slots, engagement features, offset features, or any other feature that may allow the beam 100 to be mounted to a vehicle or other components to be mounted to the beam 100.

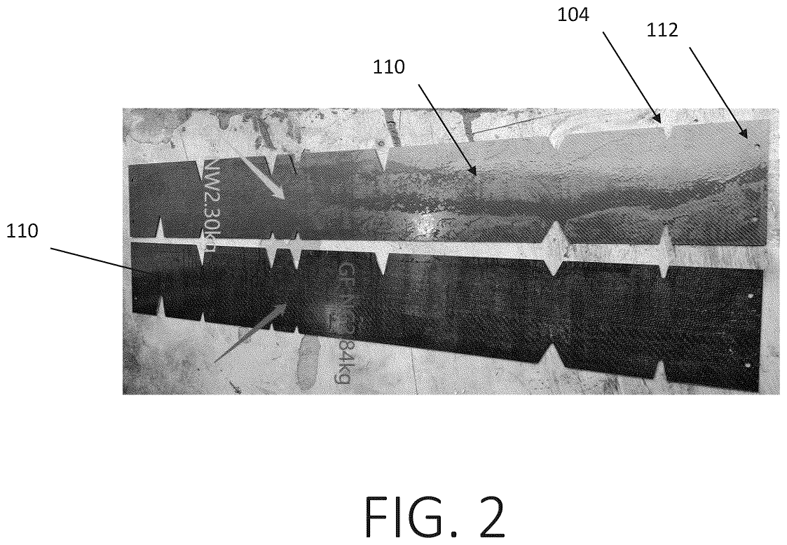

FIG. 2 is a view of the blank shape 110. In certain embodiments, the blank shape 110 is cut from a material sheet. The blank shape 110 is formed into the formed member 120. There may be a single blank shape 110 used to form the formed member 120 or multiple blank shapes 110 used to form the formed member 120. The blank shape 110 may include a plurality of locating holes 112 used to locate the blank shape 110 in the tool. The blank shape 110 may further include one or more cut outs 104. The one or more cut outs 104 may help the blank shape 110 form a formed member when it undergoes thermoforming in the tool.

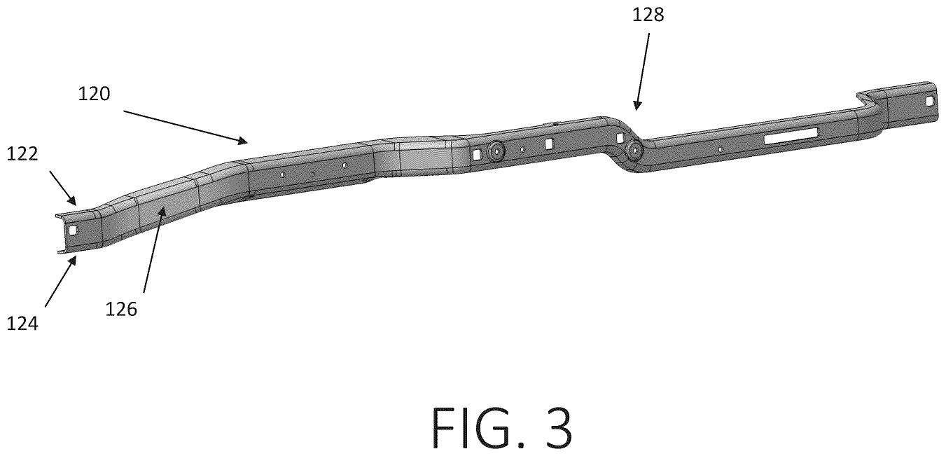

FIG. 3 is a view of the formed member 120. The formed member 120 may have a U cross sectional shape with a top face 122, a front face 124, and a bottom face 126. The formed member 120 may include a variety of different bends 128. The bend 128 may be in the Y direction such that the front face 124 does not bend but the top face 122 and the bottom face 126 do bend. The bend 128 may also be in the Z direction such that the front face 124 bends but the top face 122 and the bottom face 126 do not bend. Further the bend 128 may be a combination of X and Y bends or may include an X direction bend.

In certain embodiments, the formed member 120 may be between 2.2 and 2.4 mm thick, between 2 mm and 3 mm thick, or between 1.5 and 3.5 mm thick. In certain embodiments, the formed member may have a material density between 1.4 g/cm³ and 1.5 g/cm³, between 1.3 g/cm³ and 1.6 g/cm³, or between 1.2 g/cm³ and 1.7 g/cm³. In certain embodiments, the formed member may have a material modulus between 50 GPa and 60 GPa, between 45 GPa and 65 GPa, or between 40 GPa and 70 GPa.

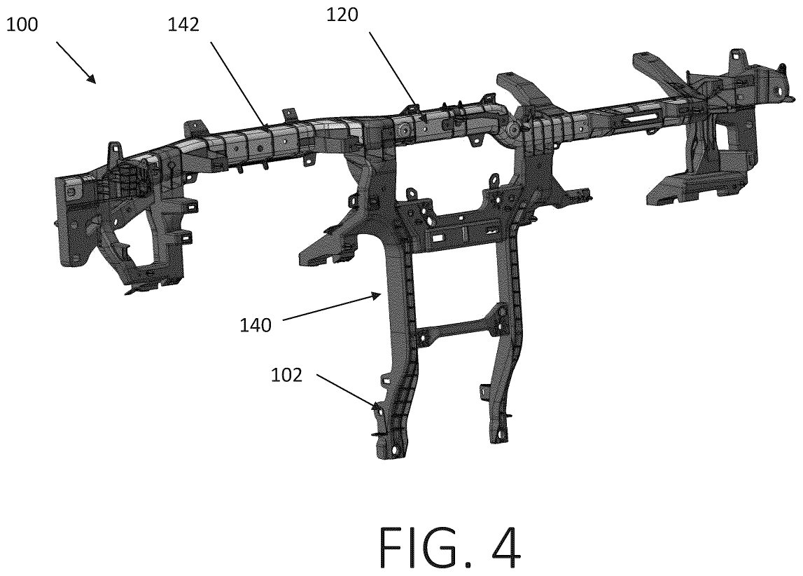

FIG. 4 is a view of the beam 100 including the formed member 120 and the overmolded portion 140. The beam 100 may be a cross member for a vehicle. The overmolded portion 140 may include a plurality of overmolding straps 142. Although the formed member 120 is directly bonded to the overmolded portion 140, in certain embodiments the overmolding straps 142 may serve to fully wrap the formed member 120.

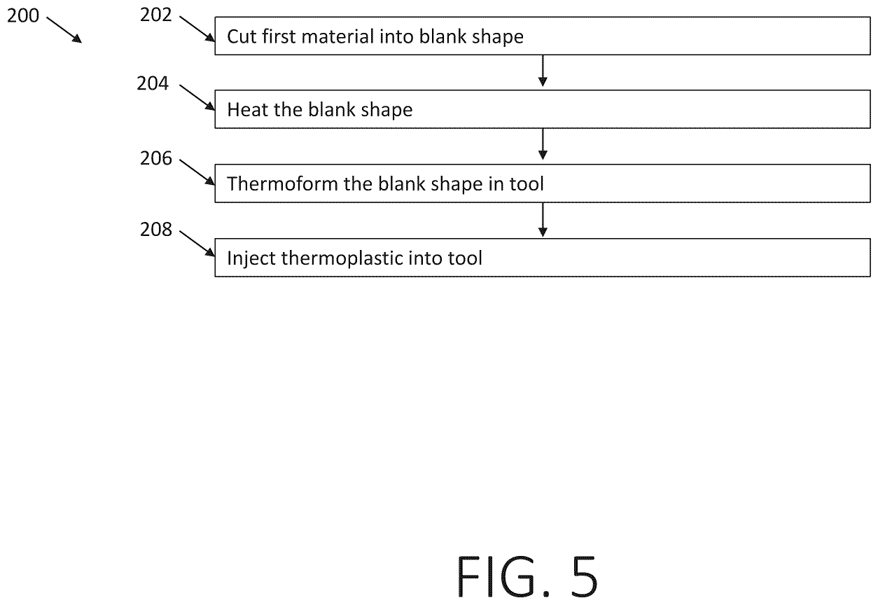

FIG. 5 is an illustration of a method 200 of forming the beam 100. The method 200 begins at step 202, cutting a first material into a blank shape 110. The first material may be any of the previously discussed combination of fiber material and a thermoplastic. Step 202 may include cutting a single blank shape 110 or multiple blank shapes 110. The first material may be cut with a laser, a waterjet, a die, or any other suitable method.

Step 204 includes heating the blank shape 110. In certain embodiments, the blank shape 110 may be heated in a dual sided oven, or any other types of ovens. The heat may make the material more malleable so that it is more easily formed.

Step 206 comprises thermoforming the blank shape(s) 110 into the formed member 120. The step 206 may include a number of sub steps such as preheating the first tool, placing the blank shape 110 into the first tool, applying pressure, compression, or heat to form the blank shape 110 into the formed member 120. Once the blank shape 110 has been formed the first tool may remain closed or be opened prior to step 208.

Step 208 includes injecting a second material into the first tool. The second material may be any injection moldable material such as, for example, polypropylene homopolymers, polypropylene copolymers, nylon homopolymers, or nylon copolymers. The step 208 may include bonding the injected second material to the formed member 120. The bonding may occur naturally due to material selection, i.e. where the thermoplastic is the same as the second material.

It should be understood that method 200 may include all of the steps 202-208 or a portion thereof. Further the method 200 may include addition steps.

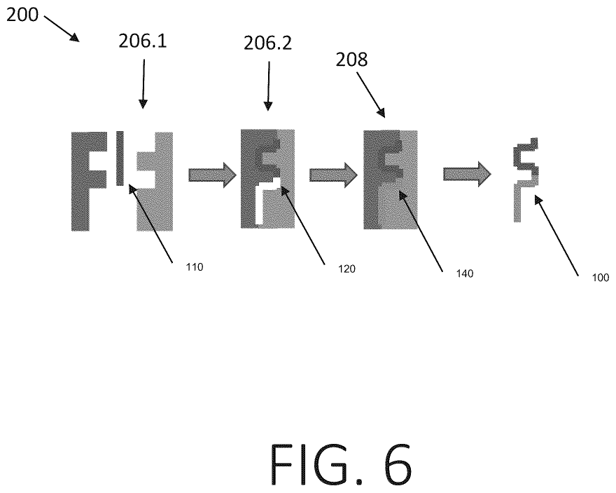

FIG. 6 is an alternative illustration of a portion of the method 200. The method includes step 206, thermoforming the blank shape 110 into the formed member 120. In the present embodiment, step 206 includes the sub step 206.1 for placing the blank shape 110 into the first tool and sub step 206.2 which includes compressing the blank shape 110 into the formed member 120. Step 208 includes injecting a second material into the first tool, i.e. overmolding the formed member 120.

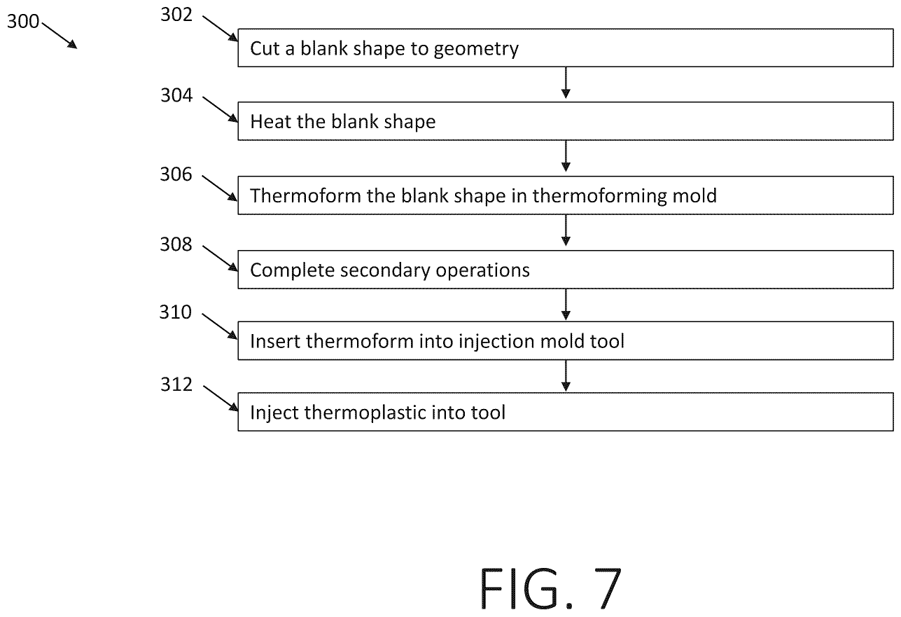

FIG. 7 is an illustration of a method 300 for forming the beam 100. The method 300 begins at step 302, cutting a first material into a blank shape 110. The first material may be any of the previously discussed combination of fiber material and a thermoplastic. The step 302 may include cutting a single blank shape 110 or multiple blank shapes 110. The step 302 may be the same as or similar to step 202.

Step 304 includes heating the blank shape 110. In certain embodiments, the blank shape may be heated in a dual sided oven. The heat may make the material more malleable so that it is more easily formed. The step 304 may be the same as or similar to step 204.

Step 306 comprises thermoforming the blank shape(s) 110 into the formed member 120. The step 306 may include a number of sub steps such as preheating the first tool, placing the blank shape 110 into the first tool, applying pressure, compression, or heat to form the blank shape 110 into the formed member 120. Once the blank shape 110 has been formed, the first tool opens so as to release the formed member 120. The step 306 may be the same as or similar to step 206. In some embodiments, the first tool may be a compression forming tool, a thermoforming tool, an injection molding tool, or any combination thereof.

Step 308 includes completing secondary operation on the formed member 120. The secondary operations may include removing excess material from the formed member 120. The secondary operation may further include adding holes, slots, or other features to the formed member 120. In some embodiments, step 308 may be optional to the method 300.

Step 310 includes placing or inserting the formed member 120 into a second tool. The second tool may be an injection molded tool. The second tool may be different from the first tool that is used in step 306.

Step 312 includes injecting a second material into the second tool. The second material may be thermoplastic resin and/or any injection moldable material such as polypropylene homopolymers, polypropylene copolymers, nylon homopolymers, nylon copolymers, or a combination thereof. The step 312 may include bonding the injected second material to the formed member 120. The bonding may occur naturally due to material selection, i.e. where the thermoplastic is the same as the second material.

It should be understood that method 300 may include all of the steps 302-312 or a portion thereof. Further the method 300 may include addition steps.

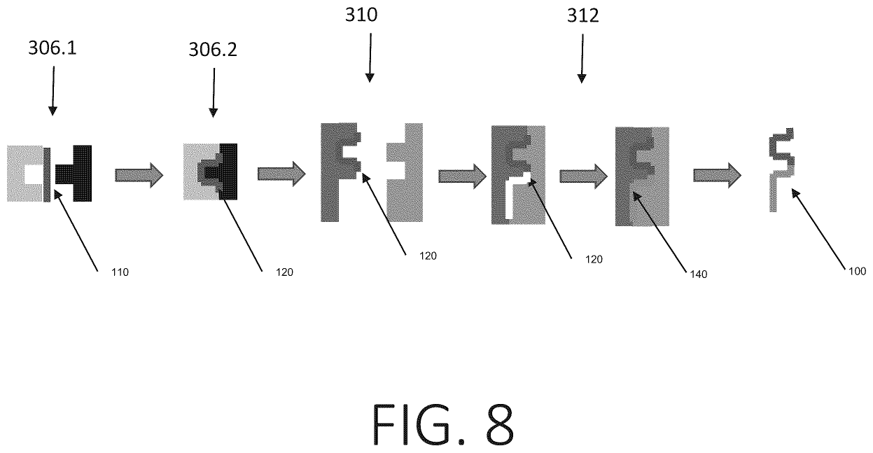

FIG. 8 is an alternative illustration of a portion of the method 300. The method includes step 306, thermoforming the blank shape 110 into the formed member 120. In the present embodiment, step 306 includes the sub step 306.1 of placing the blank shape 110 into the first tool and sub step 306.2 which includes compressing the blank shape 110 into the formed member 120. Step 310 includes placing the formed member 120 into the second tool. Step 312 includes closing the second tool and injecting a second material into the second tool. The second material for forming the overmolded portion 140 may bond to the first material of the formed member 120. For example, the first material may include thermoplastic composition. The second material may include thermoplastic resin or any other material that includes a thermoplastic composition. Because the first material and the second material share common a thermoplastic composition, bonding between the first material and the second material may occur spontaneously or naturally after the second material is injected into the second tool. Once the injection molding of step 312 is completed, the beam 100 is removed from the second tool.

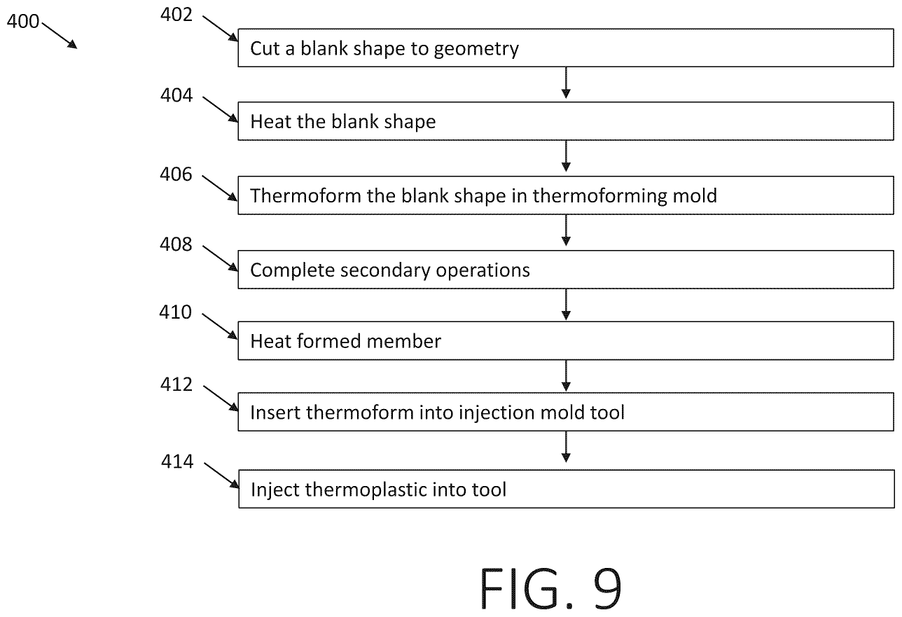

FIG. 9 is an illustration of a method 400 for forming the beam 100. The method 400 may be similar to method 200 or method 300, and may share any step previously described. The method 400 begins at step 402, cutting a first material into a blank shape 110. The first material may be any of the previously discussed combination of fiber material and a thermoplastic. The step 402 may include cutting a single blank shape 110 or multiple blank shapes 110. The step 402 may be the same as or similar to step 202 or 302.

Step 404 includes heating the blank shape 110. In certain embodiments, the blank shape may be heated in a dual sided oven, or any other types of ovens. The heat may make the material more malleable so that it is more easily formed. The step 404 may be the same as or similar to step 204 or 304.

Step 406 comprises thermoforming the blank shape(s) 110 into the formed member 120. The step 406 may include a number of sub steps such as preheating the first tool, placing the blank shape 110 into the first tool, applying pressure, compression, or heat to form the blank shape 110 into the formed member 120. Once the blank shape 110 has been formed, the first tool opens so as the release the formed member 120. The step 406 may be the same as or similar to step 206 or 306.

Step 408 includes completing secondary operation on the formed member 120. The secondary operations may include removing excess material from the formed member 120. The secondary operation may further include adding holes, slots, or other features to the formed member 120.

Step 410 includes heating the formed member 120. In certain embodiments, the formed member 120 may be heated in a dual sided oven. The heat can promote a strong bonding and/or adhesion between the formed member 120 and material that is to be injected to bond with the formed member 120. Additionally and/or optionally, adhesion promoting processes such as plasma or flame treatment may be included in step 410 to further enhance bonding.

Step 412 includes placing or inserting the formed member 120 into a second tool. The second tool may be an injection molded tool.

Step 414 includes injecting a second material into the second tool. The second material may be thermoplastic resin and/or any injection moldable material such as polypropylene homopolymers, polypropylene copolymers, nylon homopolymers, nylon copolymers, or any combination thereof. The step 414 may include bonding the injected second material to the formed member 120. The bonding may occur naturally due to material selection, i.e. where the thermoplastic is the same as the second material. For example, the first material may include thermoplastic composition. The second material may include thermoplastic resin or any other material that includes a thermoplastic composition. Because the first material and the second material share common a thermoplastic composition, bonding between the first material and the second material may occur spontaneously or naturally after the second material is injected into the second tool.

It should be understood that method 400 may include all of the steps 402-414 or a portion thereof. Further the method 400 may include addition steps.

In some examples, precise temperature control is provided for achieving optimal material properties and bonding strength. The thermoforming and overmolding processes are performed within a specific temperature range of 200° C. to 250° C., which has been found to optimize or at least enhance the bonding between the first and second thermoplastic materials. This temperature range seeks to ensure that the thermoplastics are sufficiently malleable to form strong bonds without degrading the fiber material.

To further enhance the properties of the structural elements, various post-processing treatments can be applied in some examples. These treatments include heat treatment to relieve internal stresses, UV radiation to improve environmental resistance, and chemical treatments to enhance surface properties. Each treatment is tailored to the specific requirements of the application, seeking to ensure that the final product meets the highest standards of durability and performance.

In some examples, an environmental impact of the manufacturing process and the final product is assessed through comprehensive lifecycle assessments. These assessments evaluate the carbon footprint, resource usage, and recyclability of the materials used. The fiber composite structure is designed to be environmentally friendly, with a focus on reducing waste and enabling the recycling or reuse of materials at the end of the product's lifecycle.

In some examples, the structural elements are integrated with sensors or electronic components to provide real-time monitoring capabilities. These components are embedded during the overmolding process and are capable of monitoring structural integrity, detecting stress levels, and assessing environmental conditions. This integration allows for proactive maintenance and ensures the long-term reliability of the structural element in various applications.

In some examples, the properties of the structural elements are customized to meet the specific demands of various applications. For instance, modifications in the flexibility, rigidity, or thermal insulation properties can be made to adapt the structural element for use in electric vehicles, where weight and battery efficiency may be important, or in aerospace applications, where high strength-to-weight ratios may be necessary.

### EXAMPLES

Thus, some embodiments may include one or more of the following examples.

### Example 1

A process of manufacturing a structural element, the process comprising: heating a blank shape, the blank shape comprising a composite material that comprises a fiber and a first thermoplastic; thermoforming, using a tool, the blank shape to form a thermoformed member; and overmolding, using the tool, the thermoformed member with a molding material that comprises a second thermoplastic to form the structural element, wherein overmolding the thermoformed member causes the first thermoplastic and the second thermoplastic to bond to each other.

### Example 2

The process of Example 1, further comprising cutting a composite material sheet to form the blank shape.

### Example 3

The process of Example 1 or 2, wherein thermoforming the blank shape comprises: inserting the blank shape into the tool; and compressing the blank shape into the thermoformed member.

### Example 4

The process of any one of Examples 1-3, wherein overmolding the thermoformed member comprises injecting the molding material into the tool.

### Example 5

The process of any one of Examples 1-4, wherein the thermoformed member has a first shape, and wherein overmolding causes the molding material to have a second shape that is different from the first shape.

### Example 6

The process of any one of Examples 1-5, wherein the molding material is selected from a group comprising polypropylene homopolymers, polypropylene copolymers, nylon homopolymers, nylon copolymers, and combinations thereof.

### Example 7

A process of manufacturing a structural element, the process comprising: heating a blank shape, the blank shape comprising a composite material that comprises a fiber and a first thermoplastic; thermoforming, using a first tool, the blank shape to form a thermoformed member; and overmolding, using a second tool different from the first tool, the thermoformed member with a molding material that comprises a second thermoplastic to form the structural element, wherein overmolding the thermoformed member causes the first thermoplastic and the second thermoplastic to bond to each other.

### Example 8

The process of Example 7, wherein the first tool is a compression forming tool, a thermoforming tool, or an injection molding tool.

### Example 9

The process of Example 7 or 8, wherein the structural element is a cross vehicle beam.

### Example 10

The process of any one of Examples 7-9, further comprising cutting a composite material sheet to form the blank shape.

### Example 11

The process of any one of Examples 7-10, further comprising: processing the thermoformed member; and inserting the thermoformed member into the second tool.

### Example 12

The process of Example 11, wherein processing the thermoformed member comprises removing excess material from the thermoformed member, or adding mounting holes or slots to the thermoformed member.

### Example 13

The process of Examples 11 or 12, wherein processing the thermoformed member comprises heating the thermoformed member.

### Example 14

The process of any one of Examples 7-13, wherein overmolding the thermoformed member comprises injecting the molding material into the second tool.

### Example 15

A beam comprising: a thermoformed member comprising a fiber material and a first thermoplastic material; and an overmolded member connected to the thermoformed member, the overmolded member comprising a second thermoplastic material, wherein the first thermoplastic material and the second thermoplastic material are bonded to each other to connect the thermoformed member and the overmolded member.

### Example 16

The beam of example 15, wherein the thermoformed member is devoid of steel, aluminum, or a metallic material.

### Example 17

The beam of example 15 Or 16, wherein the overmolded member comprises one or more mounting holes, or one or more mounting slots.

### Example 18

The beam of any one of examples 15-17, wherein the overmolded member comprises one or more overmolding straps to at least partially wrap the thermoformed member.

### Example 19

The beam of any one of examples 15-18, wherein the fiber material includes a carbon, aramid, or natural fiber, and wherein the first thermoplastic material and the second thermoplastic material include a nylon or thermoplastic material, or a blend thereof.

### Example 20

The beam of any one of examples 15-19, wherein the thermoformed member has a U, C, or I cross sectional shape.

### Example 21

A beam comprising: a formed member comprising a blank shape of a fiber material infused with a thermoplastic that is formed into a first shape; and an over molded member comprising an injected molded material bonded to the formed member.

### Example 22

The beam of example 21, wherein the beam is a cross vehicle beam.

### Example 23

The beam of example 21 or 22, wherein the first shape is a U shaped beam.

### Example 24

The beam of any one of examples 21-23, wherein the fiber material is a carbon fiber and the thermoplastic is a nylon.

### Example 25

The beam of any one of examples 21-24, wherein the injected molded material is nylon.

### Example 26

The beam of any one of examples 21-25, wherein the injected molded material is of a same material as the thermoplastic, and wherein the injected molded material is directly bonded to the thermoplastic during an injection molding process.

### Example 27

A method of forming a beam, the method comprising: cutting a first material into a blank shape; heating the blank shape; thermoforming the blank shape into a formed member with a first tool; inserting the formed member into an injection molding tool; injecting the injection molding tool with a second material; and bonding the first material directly to the second material.

### Example 28

The method of example 27, wherein injecting the injection molding tool with the second material further comprises directly bonding the first material to the second material.

### Example 29

A method of forming a beam, the method comprising: cutting a first material into a blank shape; heating the blank shape; thermoforming the blank shape into a formed member with a first tool; overmolding the formed member with a second material within the first tool; and bonding the first material directly to a second material.

### Example 30

The method of example 29, wherein overmolding the formed member with a second material further comprises directly bonding the second material to the formed member.

### Example 31

A structural beam comprising an overmolded member injection molded to a thermoformed member, the thermoformed member comprising a fiber material and a thermoplastic material, wherein the injection molded overmolded member comprises the thermoplastic material.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed materials, elements, and cross car beam. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. A process of manufacturing a structural element, the process comprising:
heating a blank shape, the blank shape comprising a composite material that comprises a fiber and a first thermoplastic;
thermoforming, using a tool, the blank shape to form a thermoformed member; and
overmolding, using the tool, the thermoformed member with a molding material that comprises a second thermoplastic to form the structural element, wherein overmolding the thermoformed member causes the first thermoplastic and the second thermoplastic to bond to each other.

2. The process of claim 1, further comprising cutting a composite material sheet to form the blank shape.

3. The process of claim 1, wherein thermoforming the blank shape comprises:
inserting the blank shape into the tool; and
compressing the blank shape into the thermoformed member.

4. The process of claim 1, wherein overmolding the thermoformed member comprises injecting the molding material into the tool.

5. The process of claim 1, wherein the thermoformed member has a first shape, and wherein overmolding causes the molding material to have a second shape that is different from the first shape.

6. The process of claim 1, wherein the molding material is selected from a group comprising polypropylene homopolymers, polypropylene copolymers, nylon homopolymers, nylon copolymers, and combinations thereof.

7. A process of manufacturing a structural element, the process comprising:
heating a blank shape, the blank shape comprising a composite material that comprises a fiber and a first thermoplastic;
thermoforming, using a first tool, the blank shape to form a thermoformed member; and
overmolding, using a second tool different from the first tool, the thermoformed member with a molding material that comprises a second thermoplastic to form the structural element, wherein overmolding the thermoformed member causes the first thermoplastic and the second thermoplastic to bond to each other.

8. The process of claim 7, wherein the first tool is a compression forming tool, a thermoforming tool, or an injection molding tool.

9. The process of claim 7, wherein the structural element is a cross vehicle beam.

10. The process of claim 7, further comprising cutting a composite material sheet to form the blank shape.

11. The process of claim 7, further comprising:
processing the thermoformed member; and
inserting the thermoformed member into the second tool.

12. The process of claim 11, wherein processing the thermoformed member comprises removing excess material from the thermoformed member, or adding mounting holes or slots to the thermoformed member.

13. The process of claim 12, wherein processing the thermoformed member comprises heating the thermoformed member.

14. The process of claim 12, wherein overmolding the thermoformed member comprises injecting the molding material into the second tool.

15. A beam comprising:
a thermoformed member comprising a fiber material and a first thermoplastic material; and
an overmolded member connected to the thermoformed member, the overmolded member comprising a second thermoplastic material,
wherein the first thermoplastic material and the second thermoplastic material are bonded to each other to connect the thermoformed member and the overmolded member.

16. The beam of claim 15, wherein the thermoformed member is devoid of steel, aluminum, or a metallic material.

17. The beam of claim 15, wherein the overmolded member comprises one or more mounting holes, or one or more mounting slots.

18. The beam of claim 15, wherein the overmolded member comprises one or more overmolding straps to at least partially wrap the thermoformed member.

19. The beam of claim 15, wherein the fiber material includes a carbon, aramid, or natural fiber, and wherein the first thermoplastic material and the second thermoplastic material include a nylon or thermoplastic material, or a blend thereof.

20. The beam of claim 15, wherein the thermoformed member has a U, C, or I cross sectional shape.

21. A beam comprising:
a formed member comprising a blank shape of a fiber material infused with a thermoplastic that is formed into a first shape; and
an over molded member comprising an injected molded material bonded to the formed member.

22. The beam of claim 21, wherein the beam is a cross vehicle beam.

23. The beam of claim 21, wherein the first shape is a U shaped beam.

24. The beam of claim 21, wherein the fiber material is a carbon fiber and the thermoplastic is a nylon.

25. The beam of claim 21, wherein the injected molded material is nylon.

26. The beam of claim 21, wherein the injected molded material is of a same material as the thermoplastic, and wherein the injected molded material is directly bonded to the thermoplastic during an injection molding process.

27. A method of forming a beam, the method comprising:
cutting a first material into a blank shape;
heating the blank shape;
thermoforming the blank shape into a formed member with a first tool;
inserting the formed member into an injection molding tool;
injecting the injection molding tool with a second material; and
bonding the first material directly to the second material.

28. The method of claim 27, wherein injecting the injection molding tool with the second material further comprises directly bonding the first material to the second material.

29. A method of forming a beam, the method comprising:
cutting a first material into a blank shape;
heating the blank shape;
thermoforming the blank shape into a formed member with a first tool;
overmolding the formed member with a second material within the first tool; and
bonding the first material directly to a second material.

30. The method of claim 29, wherein overmolding the formed member with a second material further comprises directly bonding the second material to the formed member.

31. A structural beam comprising an overmolded member injection molded to a thermoformed member, the thermoformed member comprising a fiber material and a thermoplastic material, wherein the injection molded overmolded member comprises the thermoplastic material.
